(19) United States
(12) Patent Application Publication
(10) Pub. No.: US 2007/0228050 A1
(43) Pub. Date: Oct. 4, 2007

(54) Fuel tank structure

(75) Inventor: Atsushi Isoda, Yokohama-shi (JP)

Correspondence Address: OSHA LIANG L.L.P., 1221 MCKINNEY STREET, SUITE 2800, HOUSTON, TX, 77010, US

(73) Assignee: Nissan Motor Co., Ltd., Yokohama-shi (JP)

(21) Appl. No.: 11/732,038

(22) Filed: Apr. 2, 2007

(30) Foreign Application Priority Data
Apr. 3, 2006 (JP) 2006-102357

(51) Int. Cl. B62D 33/00

(52) U.S. Cl. 220/562

(57) ABSTRACT

A fuel tank has a fuel tank body with an upper wall and a lower wall, an upper recess formed in the upper wall and a lower recess formed in the lower wall, and at a cover that seals the one of the upper recess or the lower recess. The upper recess and the lower recess extend into the fuel tank. Soles of the upper recess and the lower recess are abutted against each other and joined to form a first joint.

### PRIORITY APPLICATION

This application claims priority from Japanese Patent Application No. 2006-102357, filed Apr. 3, 2006, the contents of which are hereby incorporated by reference in their entirety

### BACKGROUND OF INVENTION

1. Field of the Invention

The present invention relates to a fuel tank.

2. Background Art

Some conventional fuel tanks have a fuel tank body that has a strong central portion. Recesses are formed in the fuel tank body, extending inwardly from the upper wall and the lower wall of the fuel tank body. The soles of the recesses are separated from each other, and projections disposed on the soles of the recesses are abutted against and joined to each other. An example of this conventional fuel tank can be found, for example, in Japanese Unexamined Patent application Publication No. 2-296537.

The fuel tank having the above structure has a strengthened central portion of the fuel tank body, as a result of joining the recesses to each other. Further, as a result of joining the recesss only at their projections, the joint strength is lower than the strength of the fuel tank body. Thus, when a load produced by, for example, a vehicle collision is applied to the fuel tank body, the recesses are easily detached from each other, thereby restricting cracking in the recesses.

To easily detach the recesses from each other when a load produced by, for example, a vehicle collision is applied to the fuel tank body, it is necessary to make the joining strength of the recesses weaker than the strength of the fuel tank body. Further, the joining strength between the recesses may need adjusting.

### SUMMARY OF THE INVENTION

In one or more embodiments of the present invention, a fuel tank comprises a fuel tank body comprising an upper wall and a lower wall, an upper recess formed in the upper wall and a lower recess formed in the lower wall, and at least one cover seals at least one of the upper recess and the lower recess. The upper recess and the lower recess extend into a fuel tank. Soles of the upper recess and the lower recess are abutted against each other and joined to form a first joint.

In one or more embodiments, a fuel tank comprises a resin fuel tank body comprising an upper wall and a lower wall, an upper recess formed in the upper wall and a lower recess formed in the lower wall, and a step disposed at an inner wall of at least one of the upper recess and the lower recess. The upper recess and the lower recess extend into the fuel tank. Soles of the upper recess and the lower recess are abutted against each other and joined to form a joint.

In one or more embodiments of the present invention, a method of sealing a fuel tank comprises the steps of forming an upper recess in an upper wall of a fuel tank body and a lower recess in a lower wall of the fuel tank body so that the upper recess and the lower recess extend into the fuel tank, abutting soles of the upper recess and the lower recess against each other, and hermetically sealing at least one of the upper recess and the lower recess.

In one or more embodiments of the present invention, a fuel tank comprises a fuel tank body having an upper wall and a lower wall. An upper recess is formed in the upper wall and a lower recess is formed in the lower wall, wherein the upper recess and the lower recess extend into the fuel tank, and soles of the upper recess and the lower recess are abutted against each other and joined to form a first joint. There is a means for hermetically sealing at least one the upper recess and the lower recess.

In one or more embodiments of the present invention, even if a recess is cracked by shock produced by, for example, a vehicle collision, fuel leakage from the crack can be contained in the recess by the cover, thereby restricting leakage to the outside of the fuel tank.

In one or more embodiments of the present invention, a fuel tank can stay sealed, even if a recess is cracked.

Other aspects and advantages of the invention will be apparent from the following description and the appended claims.

### BRIEF DESCRIPTION OF DRAWINGS

FIG. 1 shows a perspective view of a fuel tank according to a first embodiment of the present invention.

FIG. 2 shows a side cross-sectional view of the fuel tank according to the first embodiment of the present invention.

FIG. 3 shows a side cross-sectional view of the fuel tank according to the first embodiment of the present invention when, for example, a crash induced load is applied.

FIG. 4 shows an enlarged perspective view of cracking of the upper recess according to the first embodiment of the present invention.

FIG. 5 shows a perspective view of a fuel tank according to a second embodiment of the present invention.

FIG. 6 shows a side cross-sectional view of the fuel tank according to the second embodiment of the present invention.

FIG. 7 shows a side cross-sectional view of a fuel tank according to a third embodiment of the present invention.

FIG. 8 shows an enlarged top view of a recess according to a fourth embodiment of the present invention.

FIG. 9 shows a partial cross-sectional view of a fuel tank according to the fourth embodiment of the present invention, taken along line IX-IX of FIG. 8, wherein the recess is hermetically sealed by a cover.

### DETAILED DESCRIPTION

Exemplary embodiments of the invention will be described with reference to the accompanying figures. Like items in the figures are shown with the same reference numbers.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

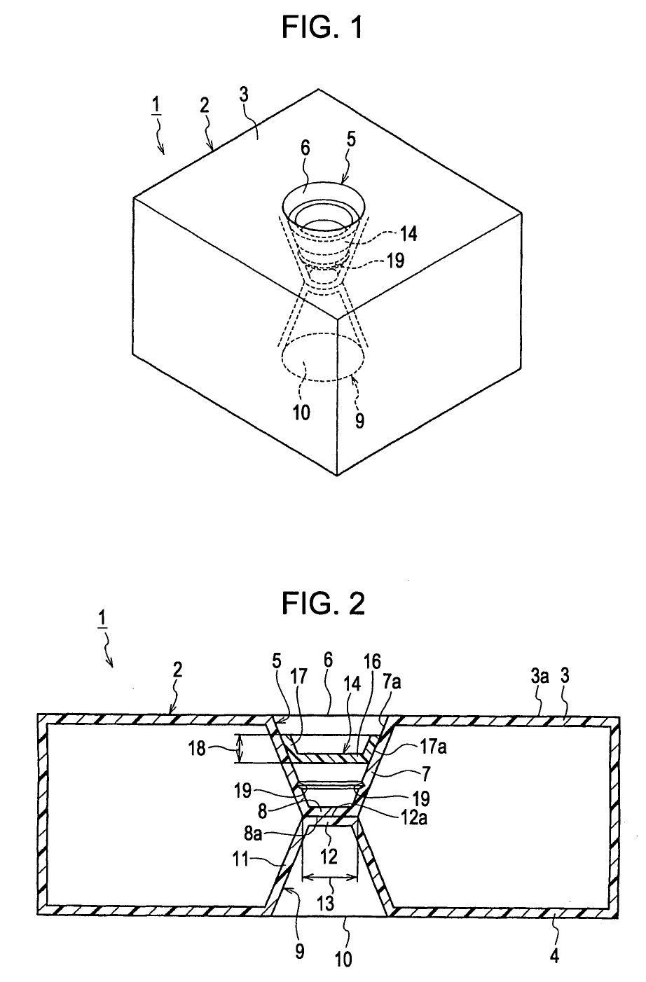

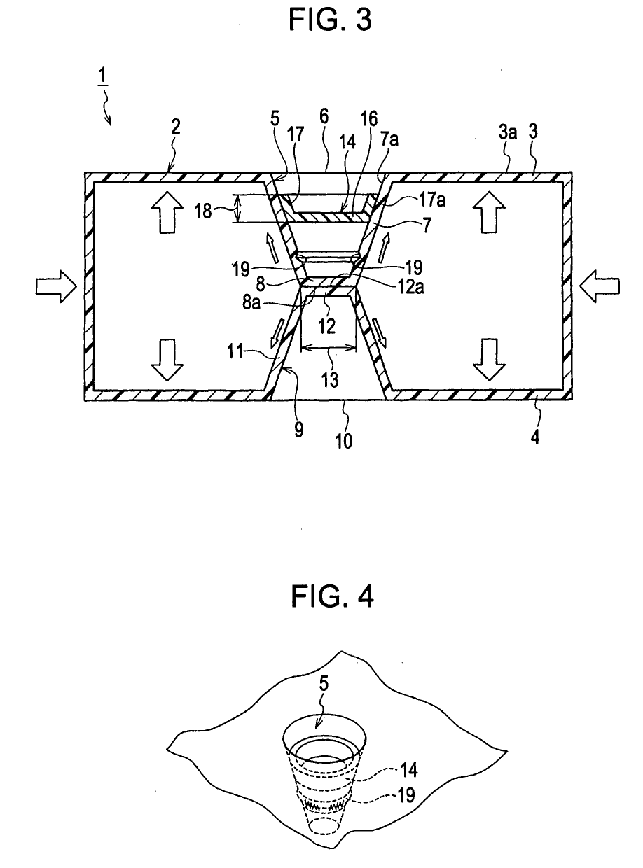

FIG. 1 shows a perspective view of a fuel tank according to a first embodiment of the present invention. FIG. 2 shows a side cross-sectional view of the fuel tank according to the first embodiment of the present invention. FIG. 3 shows a side cross-sectional view of the fuel tank according to the first embodiment of the present invention when, for example, a crash induced load is applied. FIG. 4 shows an enlarged perspective view of cracking of the upper recess according to the first embodiment of the present invention.

A fuel tank 1 according to the embodiment includes a substantially rectangular parallelepipedic fuel tank body 2 formed of synthetic resin. An upper recess 5 is formed near a central portion of an upper wall 3 of the fuel tank body 2 so as to extend into the fuel tank body 2 in a downward direction, and a lower recess 9 is formed near a central portion of a lower wall 4 of the fuel tank body 2 so as to extend into the fuel tank body 2 in an upward direction. As shown in FIG. 1, the upper recess 5 and the lower recess 9 are cup shaped, and become narrower from openings 6 and 10 towards soles 8 and 12 (back sides), respectively. That is, the upper recess 5 and the lower recess 9 are defined by the respective substantially disc-shaped soles 8 and 12 and respective peripheral walls 7 and 11 having inclined inner peripheral surfaces. The central portion of the fuel tank body 2 is strengthened by abutting a lower surface 8a of the sole 8 of the upper recess 5 against an upper surface 12a of the sole 12 of the lower recess 9, and joining the lower surface 8a and the upper surface 12a together. The lower surface 8a of the sole 8 of the upper recess 5 is joined to the upper surface 12a of the sole 12 of the lower recess 9 to form a first joint 13.

Further, the upper recess 5 is hermetically sealed by a cover 14.

The cover 14 includes a substantially disc-shaped bottom wall 16 and a flange 17 having a certain height and disposed at the peripheral edge of the bottom wall 16 so as to extend obliquely outward. An inclination angle between the flange 17 and the bottom wall 16 is made to correspond to an inclination angle between the peripheral wall 7 and the sole 8 of the upper recess 5 to bring an outer surface 17a of the flange 17 snugly into contact with an inner surface 7a of the upper recess 5, so that there is a large area of contact between the cover 14 and the upper recess 5. Accordingly, by joining the outer surface 17a of the flange 17 to the inner surface 7a of the upper recess 5, the upper recess 5 is hermetically sealed. The portion where the outer surface 17a of the flange 17 is joined to the inner surface 7a of the upper recess 5 is a second joint 18.

The peripheral wall 7 of the upper recess 5 is has a fragile portion 19 disposed between the first joint 13 and the second joint 18. The strength of the fragile portion 19 is less than the joining strength of the first joint.

In the first embodiment, when a horizontal compression load is applied to the fuel tank 1 due to, for example, a vehicle collision, as shown in FIG. 3, an upward load is applied to the upper wall 3 of the fuel tank body 2, and a downward load is applied to the lower wall 4 of the fuel tank body 2. The loads applied to the upper recess 5 and the lower recess 9 work to separate the upper recess 5 and the lower recess 9. In the first embodiment, when an excessive load is applied to the upper recess 5 and the lower recess 9, as shown in FIG. 4, the fragile portion 19 between the first joint 13 and the second joint 18 cannot resist the load and cracks, thereby cracking the upper recess 5.

However, even if the fragile portion 19 is cracked as a result of applying an excessive load to the fuel tank 1 produced by, for example, a vehicle collision, cover 14 keeps the upper recess 5 sealed. This is because the fragile portion 19 is provided between the first joint 13 and the second joint 18, that is, at a portion where the upper recess 5 is hermetically sealed by the cover 14. Since fuel leakage to the outside of the fuel tank 1 is restricted, the damaged fuel tank 1 can still be used.

In one or more embodiments of the present invention, the upper recess 5 is hermetically sealed by the cover 14, and thus a closed cross-sectional structure is formed at the upper recess 5, and rigidity of the upper recess 5 is improved. Thus, the rigidity of the fuel tank body 2 can be improved.

In one or more embodiments of the present invention, the fragile portion 19 is disposed at the peripheral wall 7 of the upper recess 5 between the first joint 13 and the second joint 18. Accordingly, when a load is applied to the fuel tank 1 due to, for example, a vehicle collision, because stress is concentrated at the fragile portion 19, cracking occurs at the fragile portion 19, and thus cracking at the other parts of the fuel tank 1 is restricted. Thus, sealability of the fuel tank 1 can be reliably ensured.

In one or more embodiments of the present invention, the fragile portion 19 is weaker than the joining strength at the first joint between the upper recess 5 and the lower recess 9. Thus, adjusting of the joining strength of the first joint where the upper recess 5 and the lower recess 9 are joined to each other may be unnecessary, thus improving working efficiency.

In one or more embodiments of the present invention, the upper recess 5 is hermetically sealed as a result of joining the cover 14 to an inner portion of the upper recess 5 that is more rigid than a tank surface. Therefore, compared to a case in which the cover 14 is joined to an upper surface 3a of the tank 1, it is possible to reduce deformation of the cover 14 when a load is applied to the fuel tank 1, which helps prevent detachment of the second joint.

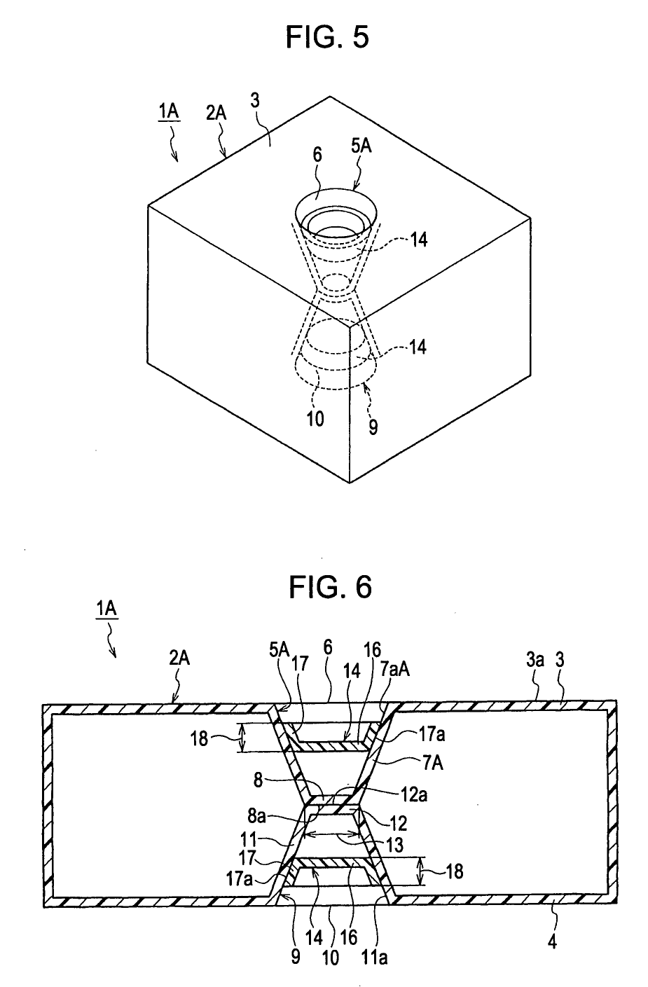

FIG. 5 shows a perspective view of a fuel tank according to a second embodiment of the present invention. FIG. 6 shows a side cross-sectional view of the fuel tank according to the second embodiment of the present invention. The fuel tank according to the second embodiment of the present invention includes some of the same structural portions as the fuel tank according to the first embodiment of the present invention. Accordingly, these same structural portions will be given the same reference numerals, and the corresponding descriptions will not be repeated below.

As shown in FIG. 6, in a fuel tank 1A according to the second embodiment of the present invention, a cover 14 is joined to an upper recess 5A formed in an upper wall 3 of a fuel tank body 2A, and a cover 14 is also joined to a lower recess 9 formed in a lower wall 4 of the fuel tank body 2A, so that both the upper recess 5A and the lower recess 9 are hermetically sealed by the respective covers 14 and 14. The shapes of the covers 14 and 14 are the same as that of the cover used in the first embodiment. As shown in FIG. 6, the upper recess 5A is hermetically sealed by joining an outer surface 17a of a flange 17 of the cover 14 to an inner surface 7aA of a peripheral wall 7A of the upper recess 5A, and the lower recess 9 is hermetically sealed by joining an outer surface 17a of a flange 17 of the other cover 14 to an inner surface 11a of the lower recess 9.

According to the second embodiment of the present invention, both the upper recess 5A and the lower recess 9 are hermetically sealed by the cover 14 and 14, and thus, even if the lower recess 9 is cracked as a result of applying a load to the fuel tank 1A produced by, for example, a vehicle collision, sealability of the fuel tank 1A can be more reliably ensured.

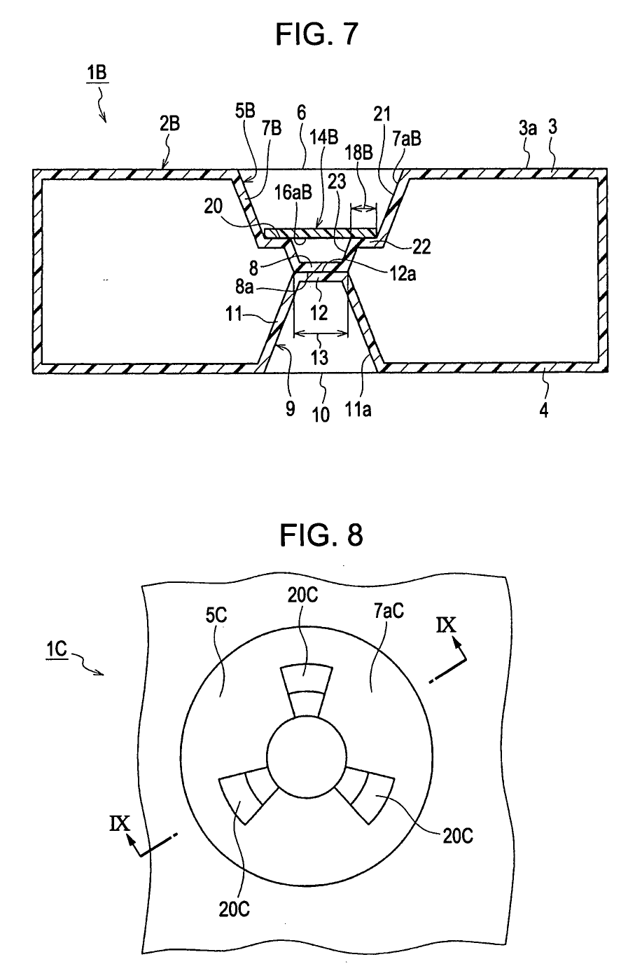

FIG. 7 shows a side cross-sectional view of a fuel tank according to a third embodiment of the present invention. The fuel tank according to the third embodiment includes some of the same structural portions as the fuel tank according to the first embodiment. Accordingly, these same structural portions will be given the same reference numerals, and the corresponding descriptions will not be repeated below.

In a fuel tank 1B according to the third embodiment of the present invention, a step is formed on an upper recess 5B that is formed in an upper wall 3 of a fuel tank body 2B, and a cover is placed on the step. More specifically, as shown in FIG. 7, a recess 23 that is smaller than a recess 21 is provided at the central portion of a bottom wall 22 of the recess 21, so that the bottom wall 22 is stepped. That is, according to the third embodiment, the bottom wall 22 corresponds to the step.

The upper surface of the bottom wall 22 is an annular flat surface 20. A substantially disc-shaped cover 14B is disposed on the flat surface 20, and the cover 14B is thus joined to the upper recess 5B.

In the third embodiment, the upper recess 5B is hermetically sealed by joining the entire circumference of a back surface 16aB of the cover 14B and the entire circumference of the flat surface 20 to each other. The back surface 16aB of the cover 14B and the flat surface 20 are joined to each other at a second joint 18B. Alternatively, a cover having a similar shape as that of the first embodiment may be used as the cover 14B. In that case, the cover 14B may be joined to the flat surface 20 and/or an inner surface 7aB of a peripheral wall 7B of the upper recess 5B.

In one or more embodiments of the present invention, a lower recess 9 in a lower wall 4 is formed of a material that is more rigid than the material used to form the upper recess 5B. In one or more embodiments of the present invention, rather than forming the lower recess 9 using a material having high rigidity, the lower recess 9 may be formed thick to increase its rigidity. In one or more embodiments of the present invention, a protecting member having the form of a sheet or a plate may be adhered or attached to the lower recess 9 to increase the rigidity of the lower recess 9.

In addition, a cover 14 having a flange 17 may be used. Here, the flange 17 is joined to the inner surface 7aB of the peripheral wall 7B of the upper recess 5B to provide the bottom wall 22 between the cover 14B and a sole 8 of the upper recess 5.

In a fuel tank 1B according to the third embodiment of the present invention, the bottom wall 22 is disposed as a step in the inner portion of the upper recess 5B, thereby making it possible to place the cover 14B on the bottom wall 22 when joining the cover 14B to the upper recess 5B. Thus, the third embodiment of the present invention has an advantage, for example, of facilitating positioning of the cover 14B when mounting the cover 14B to the upper recess 5B. Further, the third embodiment of the present invention has an advantage, for example, of improving the precision with which the cover 14B is mounted to its mounting position. Forming the upper surface of the bottom wall 22 as the substantially horizontal flat surface 20 facilitates positioning of the cover 14B when mounting it, and increases the precision with which the cover 14B is mounted to its mounting position.

The flat surface 20 makes it possible to join the cover 14B not only to the inner surface 7aB of the upper recess 5B, but also to the bottom wall 22. This increases a joining area with respect to the cover 14B by an area corresponding to the flat surface 20, increasing the joining strength.

When a flange 17 is disposed on the cover 14, a near line contact can occur if an angle between the flange 17 and a bottom wall 16 of the cover 14B does not exactly match an inclination angle between the peripheral wall 7B and a sole 8 of the upper recess 5B. But because in this embodiment, there is a flat surface 20 and the cover 14B does not have a flange 17, when the cover 14B is joined to the peripheral wall 7B of the upper recess 5B, a large contact area can be obtained. It is thus possible to reliably increase the contact area between the cover 14B and the upper recess 5B. Because the contact area between the cover 14B and the upper recess 5B is sufficiently large, it is not necessary to match the angle between the flange and the bottom wall of the cover with the shape of the inner surface 7aB of the upper recess 5B. Consequently, the shape of the cover can be simplified. However, one of ordinary skill in the art will recognize that a flange 17 could still be provided on the cover 14B in order to further increase the contact area between the cover 14B and the upper recess 5B.

By forming the lower recess 9 at the lower wall 4 using a material that is more rigid than the material used to form the upper recess 5B, stress can be concentrated at the upper recess 5 provided with the cover 14B. Therefore, it is possible to more reliably ensure sealability of the fuel tank 1.

In the one or more embodiments where the cover 14 has a flange 17 and the flange 17 is joined to the inner surface 7aB of the peripheral wall 7B of the upper recess 5B, when, for example, a resin fuel tank body 2 and receives a load as a result of, for example, a vehicle collision, the bottom wall 22 can deform elastically and absorb the load, thus restricting cracking.

Alternatively, in the one or more embodiments where a cover 14 has flange 17 and the flange 17 is joined to the inner surface 7aB of the peripheral wall 7B of the upper recess 5B, and has a bottom wall 22 between the cover 14B and the sole 8 of the upper recess 5, when the fuel tank body 2 is, for example, a metallic tank, and receives a load as a result of, for example, a vehicle collision, it is possible to concentrate stress at the bottom wall 22. Here, cracking would likely occur first at the bottom wall 22, thus restricting cracking at the other portions. That is, it is possible to more reliably ensure sealability of the fuel tank 1.

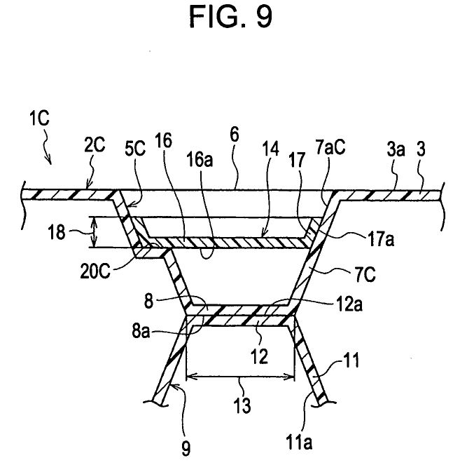

FIG. 8 shows an enlarged top view of a recess according to a fourth embodiment of the present invention. FIG. 9 shows a partial cross-sectional view of a fuel tank according to the fourth embodiment, taken along line IX-IX of FIG. 8, wherein the recess is hermetically sealed by a cover. A fuel tank according to the fourth embodiment has the some of the same structural portions as the fuel tank according to the first embodiment. Accordingly, these same structural portions will be given the same reference numerals, and the descriptions thereof will not be repeated below.

As shown in FIG. 8, in a fuel tank 1C according to the fourth embodiment, a plurality of bottom walls (steps) 22 having a finite length in a circumferential direction are provided along the circumferential direction of the inner portion of an upper recess 5C formed in an upper wall 3 of a fuel tank body 2C. The upper surfaces of the bottom walls (steps) 22 are flat surfaces 20C. Although here, three bottom walls (steps) 22 are disposed at an interval of 120 degrees in the circumferential direction, one of ordinary skill in the art will recognize that the number of steps could vary.

Here, a cover 14 has a similar shape as the cover used in the first embodiment. With a back surface 16a of a bottom wall 16 being in contact with the flat surfaces 20C, an outer surface 17a of a flange 17 is joined to an inner surface 7aC of a peripheral wall 7C of the upper recess 5C to hermetically seal the upper recess 5C. Although, in the fourth embodiment, a cover 14 is joined to the upper recess 5C only at the flange 17, it may also be joined to portions where the flat surfaces 20C and the back surface 16a of the bottom wall 16 of the cover 14 are in contact.

Although preferred embodiments of the fuel tank according to the present invention are described, the present invention is not limited to the above-described embodiments, so that various forms may be used without departing from the scope of the present invention.

For example, although, in the first to fourth embodiments, the soles of the upper and lower recesses are abutted against and joined to each other, it is possible to separate the soles from each other, provide the soles with projections, and abut the projections against each other and join them together.

In the second to fourth embodiments, a stress concentration portion, such as a fragile portion, may be provided.

Further, in the first to fourth embodiments, the fuel tank bodies and the covers may be formed with various other shapes and formed of various other materials, and the recesses may be formed with various other shapes.

What is claimed is:

1. A fuel tank comprising:
a fuel tank body comprising an upper wall and a lower wall;
an upper recess formed in the upper wall and a lower recess formed in the lower wall, wherein
the upper recess and the lower recess extend into the fuel tank, and
soles of the upper recess and the lower recess are abutted against each other and joined to form a first joint; and
at least one cover that hermetically seals one of the upper recess and the lower recess.

2. The fuel tank according to claim 1, wherein the at least one cover comprises a plurality of covers, and the plurality of covers hermetically seal the upper recess and the lower recess.

3. The fuel tank according to claim 1, wherein the at least one cover is disposed in the upper recess.

4. The fuel tank according to claim 1, wherein the at least one cover is disposed in at least one of the upper recess and the lower recess, and is joined to the at least one of the upper recess and the lower recess to form a second joint.

5. The fuel tank according to claim 1, further comprising a stress concentration portion provided between the first joint and the at least one cover.

6. The fuel tank according to claim 5, wherein the stress concentration portion is a fragile portion provided at an inner wall of the at least one of the upper recess and the lower recess.

7. The fuel tank according to claim 5, wherein the stress concentration portion is a step provided at an inner wall of the at least one of the upper recess and the lower recess.

8. The fuel tank according to claim 7, wherein the at least one cover is placed on the step.

9. The fuel tank according to claim 8, wherein the step has an outer surface that is a substantially horizontal flat surface, and the flat surface of the step and a back surface of the at least one cover are joined to each other.

10. The fuel tank according to claim 8, wherein the step is an annular step provided along an inner wall of the at least one of the upper recess and the lower recess, and having an outer surface, and an entire periphery of the outer surface of the step and an entire periphery of the back surface of the at least one cover are joined to each other.

11. The fuel tank according to claim 8, further comprising a plurality of steps provided along a peripheral direction of an inner wall of the at least one of the upper recess and the lower recess.

12. The fuel tank according to claim 1, further comprising at least one annular step and at least one fragile portion, wherein
the at least one annular step is provided along a peripheral direction of an inner wall of the at least one of the upper recess and the lower recess,
the at least one annular step has an outer surface that is a substantially horizontal flat surface,
an entire periphery of the flat surface and an entire periphery of a back surface of the at least one cover are joined to each other,
the at least one cover has a flange disposed along the inner wall,
the flange and the inner wall are joined to each other, and
the at least one fragile portion is disposed between the first joint and the at least one cover.

13. A fuel tank comprising:
a resin fuel tank body comprising an upper wall and a lower wall;
an upper recess formed in the upper wall and a lower recess formed in the lower wall, wherein
the upper recess and the lower recess extend into the fuel tank, and
soles of the upper recess and the lower recess are abutted against each other and joined to form a first joint; and
a step disposed at an inner wall of at least one of the upper recess and the lower recess.

14. The fuel tank according to claim 13, further comprising:
at least one cover that hermetically seals the at least one of the upper recess and the lower recess.

15. A method of sealing a fuel tank, comprising the steps of:
forming an upper recess in an upper wall of a fuel tank body and a lower recess in a lower wall of the fuel tank body so that the upper recess and the lower recess extend into the fuel tank;
abutting soles of the upper recess and the lower recess against each other; and
hermetically sealing at least one of the upper recess and the lower recess.

16. A fuel tank comprising:
a fuel tank body comprising an upper wall and a lower wall;
an upper recess formed in the upper wall and a lower recess formed in the lower wall, wherein
the upper recess and the lower recess extend into the fuel tank, and
soles of the upper recess and the lower recess are abutted against each other and joined to form a first joint; and
means for hermetically sealing at least one of the upper recess and the lower recess.
